(19) United States
(12) Patent Application Publication
(10) Pub. No.: US 2007/0258396 A1
(43) Pub. Date: Nov. 8, 2007

(54) MOBILE TELEPHONE-BASED PEER-TO-PEER SHARING

(75) Inventor: Alexander Tiraspolsky, Newton Centre, MA (US)

Correspondence Address: STAAS & HALSEY LLP, SUITE 700, 1201 NEW YORK AVENUE, N.W., WASHINGTON, DC, 20005, US

(73) Assignee: Comverse, Inc., Wakefield, MA (US)

(21) Appl. No.: 11/381,242

(22) Filed: May 2, 2006

(51) Int. Cl. H04Q 7/00

(52) U.S. Cl. 370/328

(57) ABSTRACT

Mobile telephone-based peer-to-peer sharing is disclosed. One method includes storing a content in a first mobile telephone and allowing a second mobile telephone to obtain the content from the first mobile telephone.

### BACKGROUND OF THE INVENTION

1. Field of the Invention

The present invention relates to mobile telephone-based peer-to-peer sharing. More particularly, the present invention relates to storing content in a first mobile telephone and allowing a second mobile telephone to obtain the content from the first mobile telephone.

2. Description of the Related Art

Mobile telephones have become commonplace in society. Mobile telephones typically connect to a telephone network through base stations via wireless radio wave technology. Using this wireless radio wave technology, voice data may be transmitted to a base station. The base station may be connected to a more conventional land-based telephone network over which the data may be transmitted.

In addition to enabling voice communication, many mobile telephones are capable of storing various types of multimedia content (“content”). Examples of content include ring tones, photos, graphic files, games, movie clips, and music files including MP3 files. This content can be played, displayed or otherwise executed on the mobile telephone.

Mobile telephones can obtain content in a variety of ways. In some cases, content may be created by the mobile telephones themselves. In other cases, content may be downloaded from a content provider. For example, a user may browse content available for download from a content service such as Cingular's™ Media Net™. Once a desired content item is found, the user may download that content item from the content service. In this case, the content is physically stored and maintained by the content service. This can be problematic for the content service for a number of reasons, including necessitating significant storage and transmission capability. Additionally, such a system does not encourage decentralized user-to-user distribution of content.

Therefore, there exists a need for a system that enables the transfer of content without a conventional content service. There also exist a need for a system and method for transferring content directly among users. Such a system and method enables easy transfer of content among mobile telephones.

### SUMMARY OF THE INVENTION

It is an aspect of the present invention to enable mobile telephone-based peer-to-peer sharing of content.

According to an aspect of the present invention, there is provided a method including storing a content in a first mobile telephone and allowing a second mobile telephone to obtain the content from the first mobile telephone.

According to another aspect of the present invention, there is provided a method including storing mobile telephone capability information for a plurality of mobile telephones, storing mobile telephone content information for the plurality of mobile telephones, and providing at least a portion of the content information to at least one of the plurality of mobile telephones. The portion of the content information is selected based at least in part on the mobile telephone capability information.

According to another aspect of the present invention, there is provided a method including receiving mobile telephone content information from a first mobile telephone and providing at least a portion of the mobile telephone content information received from the first mobile telephone to a second mobile telephone. A content selection corresponding to the provided mobile telephone content information is communicated to the first mobile telephone, and content corresponding to the content selection is transmitted to the second mobile telephone.

According to another aspect of the present invention, there is provided a computer readable storage controlling a computer according to a method. The method includes storing a content in a first mobile telephone and allowing a second mobile telephone to obtain the content from the first mobile telephone.

According to another aspect of the present invention, there is provided a system including a requesting telephone and a peer-to-peer server. The peer-to-peer server includes mobile telephone content information corresponding to content stored on a plurality of mobile telephones. A portion of the content information is provided to the requesting telephone.

According to another aspect of the present invention, there is provided a system including a first mobile telephone including a first mobile telephone storage including content, a second mobile telephone including a second mobile telephone storage, and a peer-to-peer server in communication with the first and second mobile telephones. The peer-to-peer server includes mobile telephone content information corresponding to the content stored in the first mobile telephone storage. At least a portion of the content information is provided to the second mobile telephone. The at least a portion of the content information includes a selection to download the contents from the first mobile telephone storage to the second mobile telephone storage.

According to another aspect of the present invention, there is provided an article of manufacture including a computer readable storage including a data structure, a first field including content information corresponding to content stored on a mobile telephone, and a second field including capability information for the mobile telephone.

According to another aspect of the present invention, there is provided a user interface on a first mobile telephone including a content identifier identifying a content item stored on at least a second mobile telephone.

According to another aspect of the present invention, there is provided a system including means for storing content information corresponding to content residing on a plurality of mobile telephones, means for storing capability information for the plurality of mobile telephones, and means for sharing the content residing on the plurality of mobile telephones with the plurality of mobile telephones based on the stored capability information.

The foregoing and other and other aspects will become apparent from the following detailed description of the invention when considered in conjunction with the accompanying drawing figures.

### BRIEF DESCRIPTION OF THE DRAWINGS

FIG. 1 is a schematic representation of a mobile telephone-based peer-to-peer sharing system in accordance with an embodiment of the present invention.

FIG. 2 is a schematic representation of the directory 20 of FIG. 1.

FIG. 3 is a schematic representation of peer-to-peer service logic in accordance with an embodiment of the present invention.

FIG. 4 is a schematic representation of a mobile client in accordance with an embodiment of the present invention.

FIG. 5 is a schematic representation of a process of designating sharable content to be shared over a peer-to-peer network in accordance with an embodiment of the present invention.

FIG. 6 is a schematic representation of a process of exchanging content in accordance with an embodiment of the present invention.

FIGS. 7A and 7B are schematic representations of processes of transmitting content from a content-providing telephone in accordance with an embodiment of the present invention.

FIGS. 8 and 9 are schematic representations of data flow over a mobile telephone-based peer-to-peer sharing system in accordance with an embodiment of the present invention.

FIG. 10 is a schematic representation of a mobile telephone user interface for content selection in accordance with an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention is directed to peer-to-peer sharing of content between mobile telephones.

Although the present invention is described with reference to mobile telephones, the present invention is not limited to such an implementation. For example, peer-to-peer sharing may be implemented using other suitable communication enabled devices such as handheld computing devices. Further, the present invention is described with reference to modules. One skilled in the art could appreciate that the substance of one or more of the particular modules could be embodied in one or more of another of the modules. Accordingly, the particular demarcations are made for conceptual simplicity and should not be viewed as limiting the present invention.

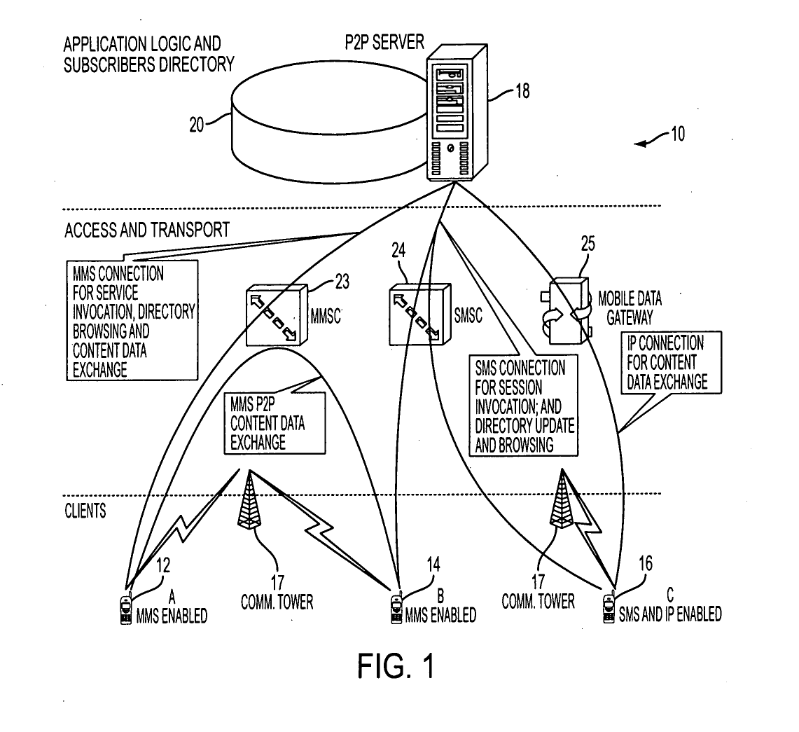

FIG. 1 is a schematic representation of a mobile telephone-based peer-to-peer sharing system 10 in accordance with an embodiment of the present invention. The system 10 may include a first mobile telephone 12, a second mobile telephone 14, and a third mobile telephone 16. The mobile telephones 12, 14, 16 may each include a mobile telephone storage including content stored thereon. The system 10 also may include communication towers 17 and a peer-to-peer server 18 in communication with the mobile telephones 12, 14, 16 via the communication towers 17 and standard interfaces such as a multimedia messaging service center (MMSC) 23, a short message service center (SMSC) 24, and/or a wireless application protocol (WAP) or mobile data gateway 25. The peer-to-peer server 18 may be embodied as hardware and/or software. The peer-to-peer server 18 may include mobile telephone capability information for the mobile telephones 12, 14, 16, and mobile telephone content information corresponding to content stored on the mobile telephones 12, 14, 16.

As discussed in greater detail below, the mobile telephone capability information may include, for example, a device identifier and a communication protocol identifier. The mobile telephone content information may include, for example, a content identifier and other descriptive attributes.

A portion of content information corresponding to content stored on one of the mobile telephones 12, 14, 16 may be provided to another one of the mobile telephones 12, 14, 16. The providing of content information optionally may occur upon the occurrence of a predetermined condition involving the capability information of the mobile telephones 12, 14, 16. The portion of the content information may include a selection to download the contents from the other mobile telephone. For example, a user may see a list of MP3 files available for download from other mobile telephones. The user may select a particular MP3 file and then receive a copy of that MP3 file.

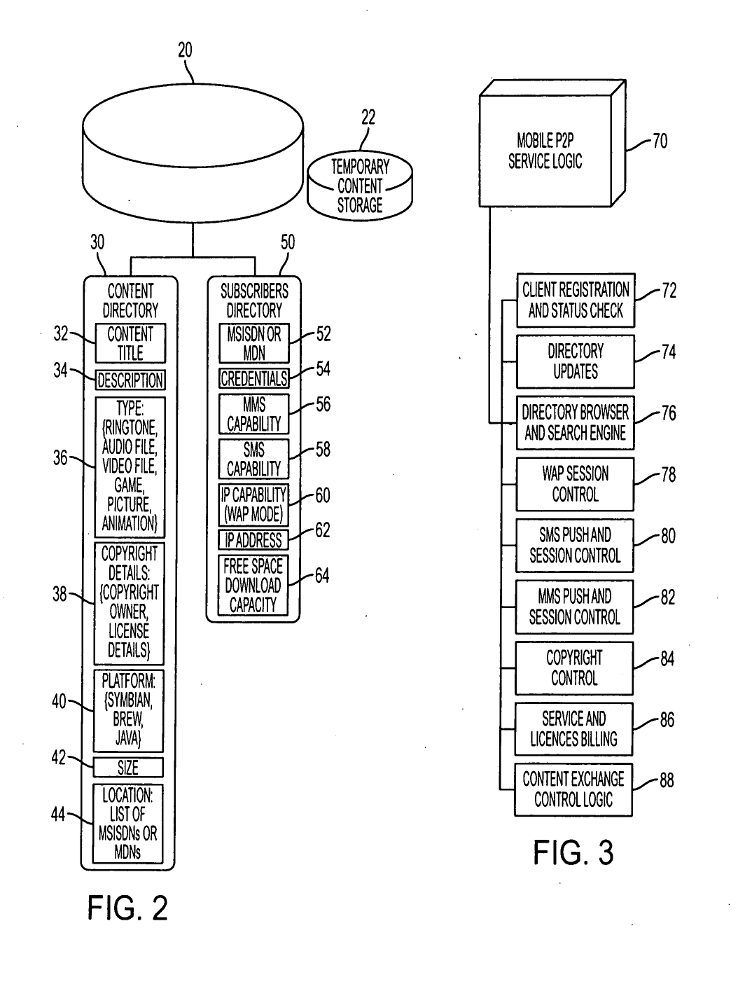

The peer-to-peer server 18 may include a directory 20 (or directories) to store the mobile telephone capability information and the mobile telephone content information for the mobile telephones 12, 14, 16. The peer-to-peer server 18 may also include a temporary content storage 22 (FIG. 2) or cache to temporarily store content transferred among the mobile telephones 12, 14, 16.

FIG. 2 is a schematic representation of the directory 20 of FIG. 1. The directory 20 may be embodied in alternative configurations. In one embodiment, the directory 20 comprises a content directory database 30 and a subscriber directory database 50. The term database is used broadly to include collections of data.

Turning to the content directory database 30, each record may include a content title 32, a content description 34, content type 36, details regarding any associated copyright and related information 38, a content platform 40, a content size 42, and/or a list of locations where the physical content resides 44. The content type 36 may indicate if the content is a ring-tone, an audio file, etc. The list of locations where the physical content resides 44 may include Mobile Station International Subscriber Directory Numbers (MSISDNs) or mobile directory numbers (MDNs).

Turning now to the subscriber directory database 50, each record may include a subscriber device identifier 52, credentials information 54, multimedia message service (MMS) capability information 56, short message service (SMS) capability information 58, IP capability (WAP mode) 60, an IP address 62, and free space download capacity 64. The subscriber device identifier 52 may include a MSISDN or a MDN.

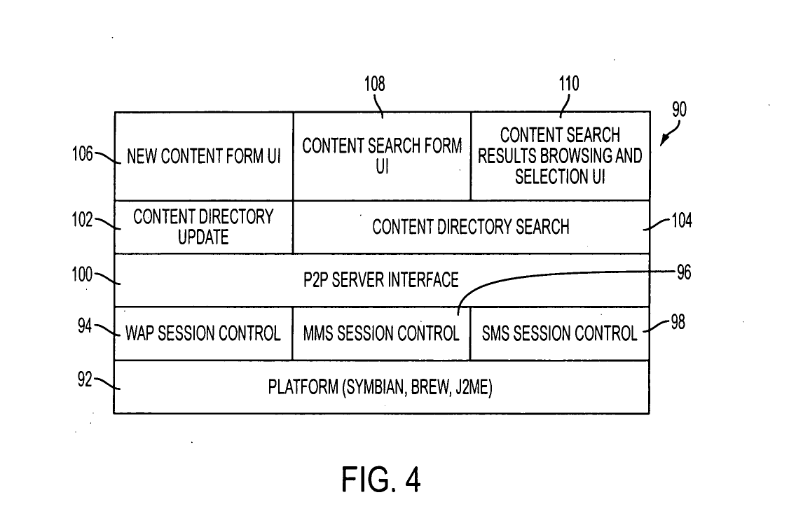

The peer-to-peer server 18 may include peer-to-peer service logic 70 (FIG. 3). The peer-to-peer service logic 70 may provide a portion of content information corresponding to the content stored on one of the mobile telephones 12, 14, 16 to another one of the mobile telephones 12, 14, 16.

FIG. 3 is a schematic representation of a peer-to-peer service logic 70 in accordance with an embodiment of the present invention. The peer-to-peer service logic 70 may include a client registration and status check module 72, a directory updates module 74, a directory browser and search engine module 76, a WAP session control module 78, a SMS push and session control module 80, a MMS push and session control module 82, a copyright control module 84, a service and licenses billing module 86, and a content exchange control logic 88.

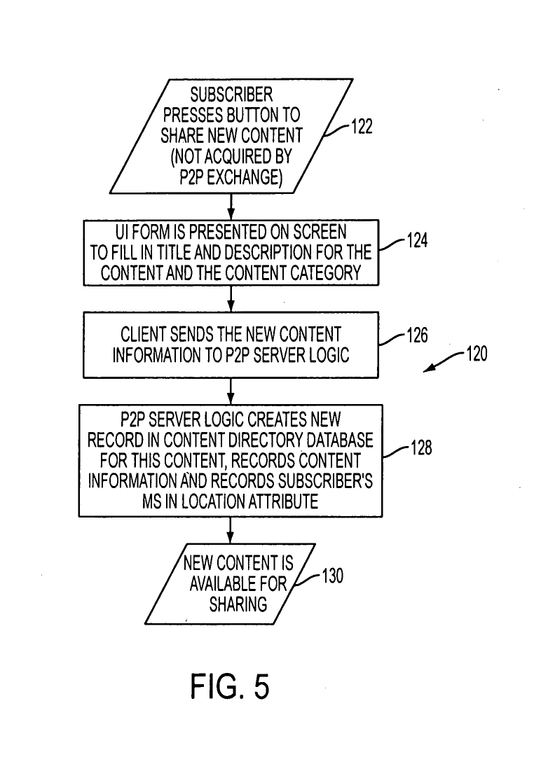

The mobile telephones 12, 14, 16 may include a client application. FIG. 4 is a schematic representation of a mobile client architecture 90 in accordance with an embodiment of the present invention. The client application may be based on an appropriate software platform 92 for mobile devices. Readily known software platforms include: Symbian OS® by Symbian Software Ltd, London, United Kingdom; Brew® by Qualcomm Inc., San Diego, Calif.; and J2ME® by Sun Microsystems, Inc., Santa Clara Calif.

The mobile client architecture 90 may include a WAP session control module 94, an MMS session control module 96, and/or an SMS session control module 98. These modules may be responsible for transport or content directory search requests from the mobile telephone to the peer-to-peer server 18, and transport of content search results form the peer-to-peer server 18 to the mobile telephone.

The SMS control module 98 may be responsible for WAP PUSH session initiation to download content from the temporary content storage 22 on the peer-to-peer server 18. The WAP session control module 94 may be responsible for WAP upload of content from the mobile telephone to the temporary content storage 22 on the peer-to-peer server 18. The WAP session control module 94 may be responsible for WAP download of content from the temporary content storage 22 to the mobile telephone. The MMS session control module 96 may be responsible for sending content from the mobile telephone to a requesting mobile telephone and for receiving content from the mobile telephone that stores the content.

The mobile client architecture 90 may include a peer-to-peer server interface 100, a content directory update module 102, a content directory search module 104, a new content form user interface 106, a content search form user interface 108, and/or a content search results browsing and selection user interface 110.

The peer-to-peer server interface 100 may be responsible for managing content directory browsing, searching and selection sessions with the peer-to-peer server 18, and for receiving peer-to-peer server 18 messages that start MMS or WAP sessions for content sending, downloading, or uploading.

The content directory update module 102 may be responsible for sending new shared content information to the peer-to-peer server 18 to create a new record in the directory 20 or to add the current mobile telephone to the list of locations for the particular content item. The content directory update module 102 may also be responsible for updating the peer-to-peer server 18 when shared content is removed from the mobile telephone. For example, the mobile telephone may be removed from the list of locations for the particular content item. If the mobile telephone is the only location for the particular content item, the content item record may be removed from the directory 20.

The content directory search module 104 may be responsible for sending content request messages to the peer-to-peer server 18 and receiving search results from the peer-to-peer server using MMS, WAP, and/or SMS transport.

The new content form user interface 106 may be responsible for collecting title and description information for a new content item acquired by the mobile telephone other than by peer-to-peer exchange. The new content form user interface 106 may be activated when the subscriber selects a share option for the content item via the mobile telephone interface.

The content search form interface 108 may be responsible for collecting the search request data such as a full or partial title and/or description. The content search form user interface 108 may be activated when a subscriber selects a search for content option via the mobile telephone interface.

The content search results browsing and selection user interface 110 may be responsible for displaying on the screen of the mobile telephone, the titles and/or descriptions of the content items that match a search request and/or that are received from the peer-to-peer server 18. The content search results browsing and selection user interface 110 also may accept input requesting more search results, select the content item causing a get request, and/or transfer the selected content identification to the peer-to-peer server that will proceed with an exchange.

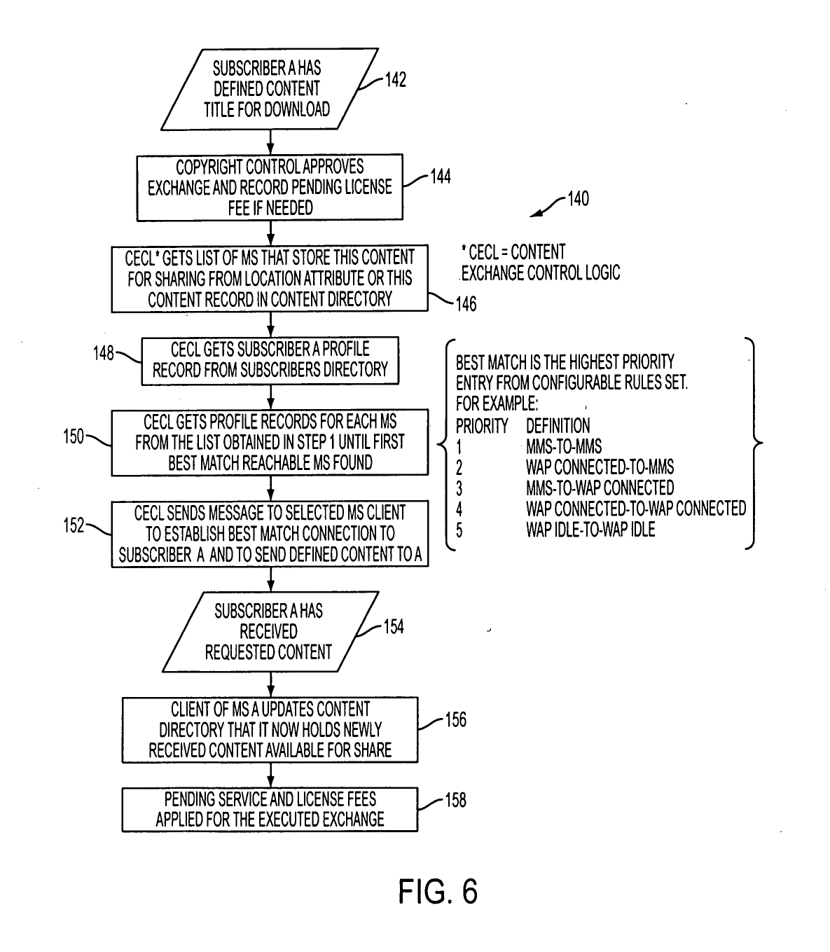

FIG. 5 is a schematic representation of a process of designating sharable content 120 to be shared over a peer-to-peer network, such as the system of FIG. 1, in accordance with an embodiment of the present invention. The process of designating sharable content 120 may be used when a content item is acquired by means other than peer-to-peer sharing. For example, a user may acquire a content item by purchasing the content item from a content provider.

In operation 122, a user or subscriber may press a button or otherwise indicate that a particular content item is available for sharing. In operation 124, a new content form user interface 106 may be presented to a user to obtain content information such as a title and a description. In operation 126, that content information may be transmitted to the peer-to-peer service logic 70. In operation 128, the peer-to-peer service logic 70 may create a new record in the content directory database 30, and record the content title 32 and the content description 34. The peer-to-peer service logic 70 may also record the subscriber's mobile telephone in the list of locations where the physical content resides 44. In operation 130, new content may be available for sharing over the peer-to-peer network.

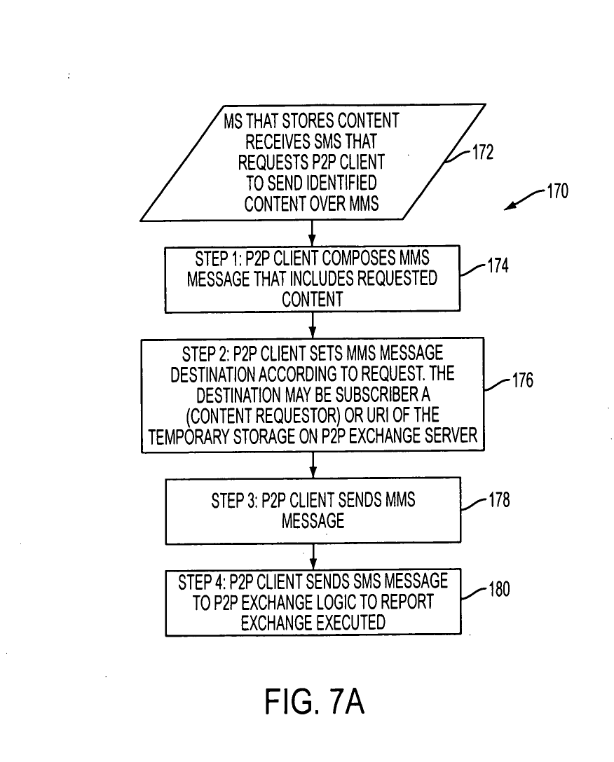

FIG. 6 is a schematic representation of a process of exchanging content 140 in accordance with an embodiment of the present invention. In operation 142, Subscriber A may define a content title for download. In operation 144, the copyright control module 84 may approve a content exchange and/or record a pending licensee fee, if needed. In operation 146, content exchange control logic (CECL) may obtain a list of mobile telephones (mobile subscribers—MS) that store the content defined from the content directory database 30. In operation 148, the CECL may obtain Subscriber A's profile record from the subscriber directory database 50. In operation 150, the CECL may obtain profile records for each mobile telephone from the list obtained in operation 146 until the nth best match reachable mobile telephone is found. In an embodiment, the nth best mach is the first best match.

In operation 152, the CECL may send a message to a selected mobile telephone client that stores the desired content to establish a best match connection to Subscriber A and to send the contents to Subscriber A. In operation 154, Subscriber A may receive the defined content. In operation 156, the mobile telephone client of Subscriber A may update the content directory database 30 to reflect that Subscriber A now is a location where the newly received content is stored and is available to be shared. In operation 158, any pending service and licensee fees are applied for the executed exchange.

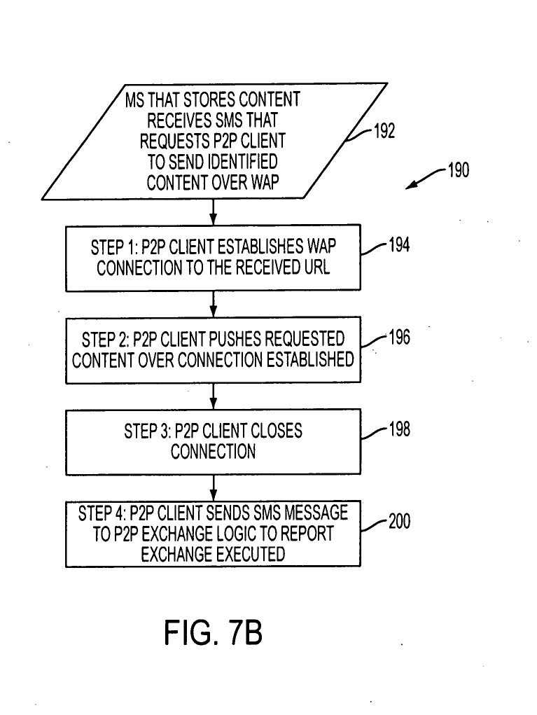

FIGS. 7A and 7B are schematic representations of processes of transmitting content from a content-providing telephone in accordance with an embodiment of the present invention.

In FIG. 7A, a process 170 of transmitting content including an MMS exchange is described. In operation 172, a mobile telephone that has a desired content stored thereon may receive an SMS request to send the desired content using MMS. In operation 174, the mobile telephone may compose an MMS message including the desired content. In operation 176, the mobile telephone may set the message destination according to the received request. The destination may be another mobile telephone (the content requester), or it may be a uniform resource indicator (URI) of the temporary storage 22. In operation 178, the mobile telephone may send the MMS message. In operation 180, the mobile telephone may send an SMS message to the CECL to report that the exchange has been executed.

In FIG. 7B, a process 190 of transmitting content using a WAP exchange is described. In operation 192, a mobile telephone that has a desired content stored thereon may receive an SMS request to send the desired content using WAP. In operation 194, the mobile telephone may establish a WAP connection to a received uniform resource locator. In operation 196, the mobile telephone may push the requested content over the established connection. In operation 198, the mobile telephone may close the connection. In operation 200, the mobile telephone may send an SMS message to the CECL to report that the exchange has been executed.

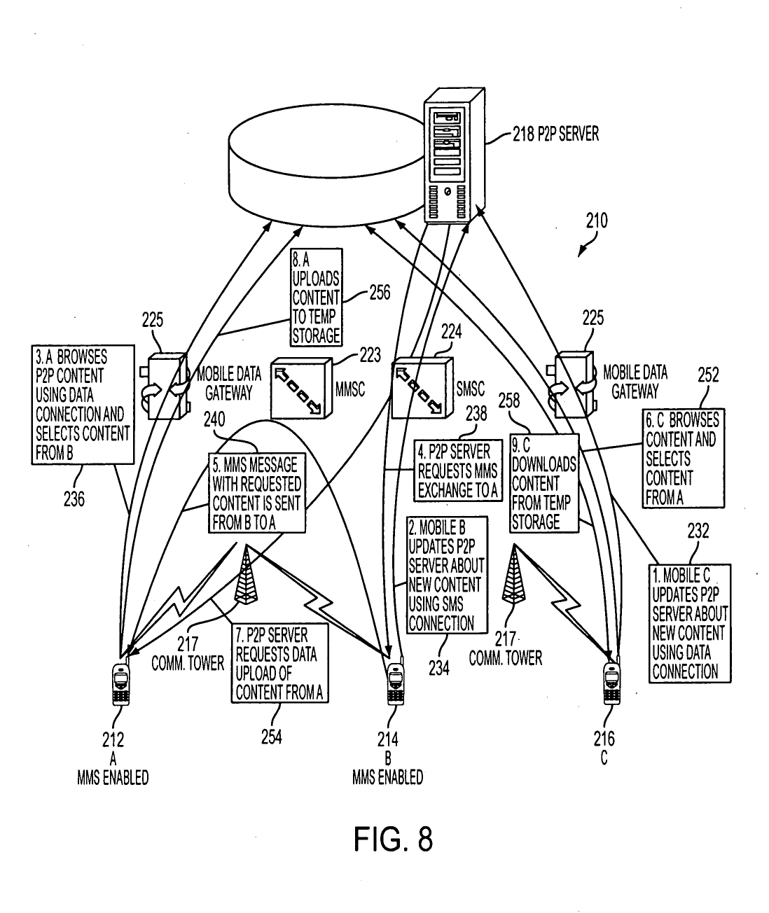

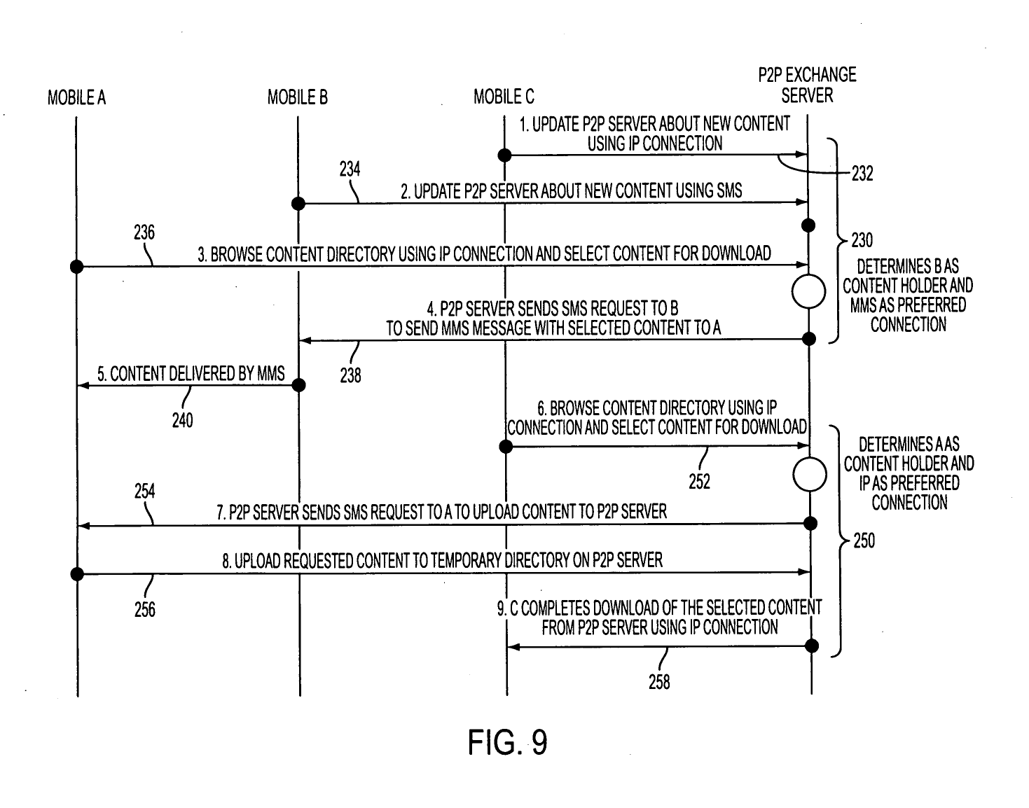

FIGS. 8 and 9 are schematic representations of data flow processes over a mobile telephone-based peer-to-peer sharing system 210 in accordance with an embodiment of the present invention. The mobile telephone-based peer-to-peer sharing system 210 may include mobile telephone A 212, mobile telephone B 214, and mobile telephone C 216. The system 210 also may include communication towers 217 and a peer-to-peer server 218 in communication with the mobile telephones 212, 214, 216 via the communication towers 217 and standard interfaces such as a MMSC 223, a SMSC 224, and/or mobile data gateways 225. The peer-to-peer server 218 may include telephone capability information for the mobile telephones 212, 214, 216, and mobile telephone content information corresponding to content stored on the mobile telephones 212, 214, 216.

In a first teaching, a data flow process 230 (FIG. 9) including an MMS exchange is described. In operation 232, Mobile C 216 may update the peer-to-peer server 218 with content information corresponding to a new content item stored thereon using a data connection through a mobile data gateway 225. In operation 234, Mobile B 214 may update the peer-to-peer server 218 with content information corresponding to a new content item using an SMS connection through the SMSC 224. In operation 236, Mobile A 212 may browse content using a data connection through a mobile data gateway 225. The content item physically located on Mobile B 214 may be selected.

In operation 238, the peer-to-peer server 218 may request an MMS exchange from Mobile B 214 to Mobile A 212. In operation 240, an MMS message with the content item may be sent from Mobile B 214 to Mobile A.

In a second teaching, a data flow process 250 including a temporary storage exchange is described. In operation 252, Mobile C 216 may browse content and select a content item to be downloaded. The content item selected may physically reside on Mobile A 212. Browsing and/or selecting may be accomplished using an IP connection.

In operation 254, the peer-to-peer server 218 may request the uploading of the content item. In operation 256, the content item may be uploaded to temporary storage. In one embodiment, the temporary storage is embodied as a temporary directory on the peer-to-peer server 218. In operation 258, Mobile C 216 may receive the content item from the temporary storage. The receiving may be accomplished using an IP connection.

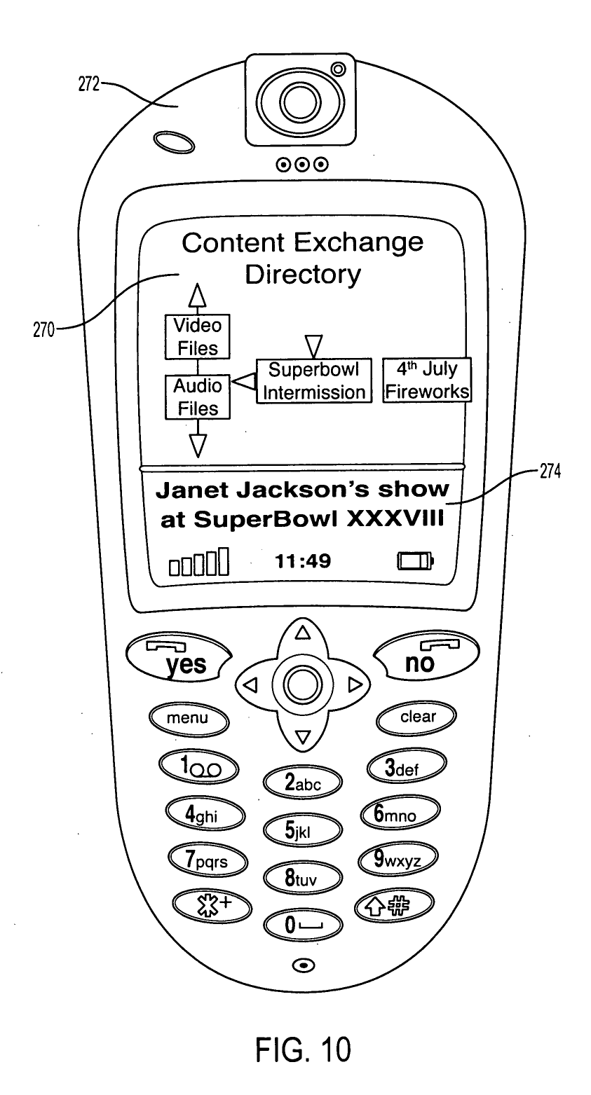

FIG. 10 is a schematic representation of a mobile telephone user interface for content selection 270 in accordance with an embodiment of the present invention. The mobile telephone user interface 270 may be embodied as a display on a mobile telephone 272. The mobile telephone user interface 270 may display a content identifier 274. The content identifier 274 may identify content stored on a different mobile telephone. The mobile telephone user interface 270 may also comprise content categories. The content categories may be navigated using screen navigation buttons provided on the mobile telephone 272. A content item may be obtained by selecting the content identifier 274 using a screen navigation button.

In addition to the components of the various embodiments, the system also may include permanent or removable storage, such as magnetic and optical discs, RAM, ROM, etc. on which the process and data structures of the present invention can be stored and distributed. The processes may also be distributed via, for example, downloading over a network such as the Internet.

The above exemplary embodiments enable mobile telephone-based peer-to-peer sharing of content.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method, comprising:
storing a content in a first mobile telephone; and
allowing a second mobile telephone to obtain the content from the first mobile telephone.

2. The method of claim 1, wherein the allowing of the second mobile telephone to obtain the content from the first mobile telephone, comprises:
providing to the second mobile telephone a content identifier corresponding to the content in the first mobile telephone.

3. The method of claim 2, wherein the content identifier is provided to the second mobile telephone through a server including a plurality of content identifiers.

4. The method of claim 1, wherein the allowing of the second mobile telephone to obtain the content from the first mobile telephone, comprises:
providing a content selection to the first mobile telephone from the second mobile telephone.

5. A method, comprising:
storing mobile telephone capability information for a plurality of mobile telephones;
storing mobile telephone content information for the plurality of mobile telephones; and
providing at least a portion of the content information to at least one of the plurality of mobile telephones,
wherein the portion of the content information is selected based at least in part on the mobile telephone capability information.

6. The method of claim 5, wherein the storing of the mobile telephone capability information comprises:
storing at least one of SMS, MMS, and IP capability information.

7. The method of claim 5, wherein the storing of the mobile telephone content information comprises:
storing at least one of a content identifier of a content item and a storage location of the content item.

8. A method, comprising:
receiving mobile telephone content information from a first mobile telephone; and
providing at least a portion of the mobile telephone content information received from the first mobile telephone to a second mobile telephone,
wherein a content selection corresponding to the provided mobile telephone content information is communicated to the first mobile telephone, and
wherein content corresponding to the content selection is transmitted to the second mobile telephone.

9. The method of claim 8, further comprising:
receiving mobile telephone capability information from the first mobile telephone,
wherein the providing of at least a portion of the mobile telephone content information occurs upon the occurrence of a predetermined condition involving the first mobile telephone capability and a mobile telephone capability of the second mobile telephone.

10. The method of claim 8, wherein the providing of at least a portion of the mobile telephone content information comprises:
providing a content selection option to result in the content selection if selected.

11. The method of claim 8, wherein the receiving mobile telephone content information from a first mobile telephone comprises:
receiving at least one of a content identifier of a content item and a storage location of the content item.

12. The method of claim 9, wherein the receiving mobile telephone capability information from a first mobile telephone comprises:
receiving at least one of SMS, MMS and IP capability information.

13. A computer readable storage controlling a computer according to a method, the method comprising:
storing a content in a first mobile telephone; and
allowing a second mobile telephone to obtain the content from the first mobile telephone.

14. A system, comprising:
a requesting telephone; and
a peer-to-peer server comprising:
mobile telephone content information corresponding to content stored on a plurality of mobile telephones,
wherein a portion of the content information is provided to the requesting telephone.

15. The system of claim 14, wherein the peer-to-peer server further comprises mobile telephone capability information for the plurality of mobile telephones, and wherein the portion of the content information is selected based at least in part on the mobile telephone capability information.

16. The system of claim 14, wherein the mobile telephone content information comprises at least one of a content identifier and a storage location.

17. The system of claim 15, wherein the mobile telephone capability information comprises at least one of SMS, MMS, and IP capability information.

18. A system, comprising:
a first mobile telephone including a first mobile telephone storage including content;
a second mobile telephone including a second mobile telephone storage; and
a peer-to-peer server in communication with the first and second mobile telephones, the peer-to-peer server comprising:
mobile telephone content information corresponding to the content stored in the first mobile telephone storage,
wherein at least a portion of the content information is provided to the second mobile telephone, and
wherein the at least a portion of the content information includes a selection to download the contents from the first mobile telephone storage to the second mobile telephone storage.

19. The system of claim 18, wherein the peer-to-peer server further comprises mobile telephone capability information for the first and second mobile telephones, and wherein the at least a portion of the content information is provided to the second mobile telephone upon the occurrence of a predetermined condition involving the capability information for the first and second mobile telephones.

20. The system of claim 19, wherein the mobile telephone capability information comprises at least one of SMS, MMS, and IP capability information.

21. The system of claim 18, wherein the mobile telephone content information comprises at least one of a content identifier and a storage location.

22. An article of manufacture, comprising:
a computer readable storage including a data structure;
a first field comprising content information corresponding to content stored on a mobile telephone; and
a second field comprising capability information for the mobile telephone.

23. A user interface on a first mobile telephone, comprising:
a content identifier identifying a content item stored on at least a second mobile telephone.

24. A user interface as recited in claim 23, wherein the content identifier may be selected to activate download of the content item from the second mobile phone to the first mobile phone.

25. A system, comprising:
means for storing content information corresponding to content residing on a plurality of mobile telephones;
means for storing capability information for the plurality of mobile telephones; and
means for sharing the content residing on the plurality of mobile telephones with the plurality of mobile telephones based on the stored capability information.
